(19) United States
(12) Patent Application Publication
(10) Pub. No.: US 2026/0353507 A1
(43) Pub. Date: Nov. 5, 2026

(54) METHOD AND APPARATUS FOR PERFORMING SCHEDULING REQUEST IN MOBILE COMMUNICATION SYSTEM

(71) Applicant: Samsung Electronics Co., Ltd., Suwon-si, Gyeonggi-do (KR)

(72) Inventors: Sangbum KIM, Suwon-si (KR); Sangkyu BAEK, Suwon-si (KR)

(21) Appl. No.: 19/482,188

(22) PCT Filed: May 9, 2024
(86) PCT No.: PCT/KR2024/006226

§ 371 Date: Nov. 6, 2025

(30) Foreign Application Priority Data
May 10, 2023 (KR) 10-2023-0060683

(51) Int. Cl. H04W 76/28; H04W 74/0833; H04W 76/50

(52) U.S. Cl. CPC H04W 76/28; H04W 74/0833; H04W 76/50

(57) ABSTRACT

The present disclosure relates to a 5G or 6G communication system for supporting higher data transmission rates. A method performed by a user equipment (UE) in a wireless communication system may comprise the steps of: receiving, from a base station, configuration information about cell discontinuous reception (DRX) configured in a cell of the base station; identifying, on the basis of the configuration data, that the cell is in a non-active period of the cell RX, and performing a random access procedure when an emergency service is to be initiated while the cell is in the non-active period.

### TECHNICAL FIELD

The disclosure relates to a wireless communication and, more particularly, to a method and an apparatus for performing a scheduling request in a mobile communication system.

### BACKGROUND ART

5G mobile communication technologies define broad frequency bands to enable high transmission rates and new services, and can be implemented not only in “Sub 6 GHz” bands such as 3.5 GHz, but also in ultrahigh frequency (“Above 6 GHz”) bands referred to as mmWave such as 28 GHz and 39 GHz. In addition, it has been considered to implement 6G mobile communication technologies (referred to as Beyond 5G systems) in terahertz bands (e.g., 95 GHz to 3THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Provided according to an embodiment of the disclosure are an apparatus and a method capable of effectively providing services in a mobile communication system.

### Solution to Problem

According to an embodiment of the disclosure, a method performed by a user equipment (UE) in a wireless communication system may include receiving, from a base station, configuration information on cell discontinuous reception (DRX) configured for a cell of the BS, identifying that the cell is in a non-active period of the cell DRX based on the configuration information, and performing a random access procedure in case that an emergency service is to be initiated while the cell is in the non-active period.

### Advantageous Effects of Invention

According to an embodiment of the disclosure, an apparatus and a method capable of effectively providing services in a wireless communication system can be provided.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF DRAWINGS

FIG. 1 illustrates a structure of a mobile communication system according to an embodiment of the disclosure.

FIG. 2 illustrates radio access state transition in a mobile communication system according to an embodiment of the disclosure.

FIG. 3 is a diagram illustrating cell DTX/DRX for reducing power consumption of a BS according to an embodiment.

FIG. 4 is a diagram illustrating a process in which a UE transmits an SR and receives allocation of radio resources from the BS according to an embodiment.

FIG. 5 is a diagram illustrating a DRX operation during SR transmission according to an embodiment.

FIG. 6 is a diagram illustrating transmission delay of the SR related to data transmission having a high priority according to an embodiment.

FIG. 7 is a diagram illustrating a method of reducing a delay time and power consumption according to an embodiment.

FIG. 8 is a diagram illustrating an SR retransmission problem due to a non-active period of cell DTX according to an embodiment.

FIG. 9 is a diagram illustrating a method of reducing power consumption according to an embodiment.

FIG. 10 is a diagram illustrating a method of reducing power consumption according to an embodiment.

FIG. 11 is a diagram illustrating a method of reducing power consumption according to an embodiment.

FIG. 12 is a diagram illustrating a method of reducing power consumption according to an embodiment.

FIG. 13 is a flowchart illustrating a UE operation according to an embodiment of the disclosure.

FIG. 14 is a flowchart of a BS operation according to an embodiment.

FIG. 15 is a block diagram illustrating an internal structure of a UE according to an embodiment.

FIG. 16 is a block diagram illustrating a structure of a base station according to an embodiment.

FIG. 17 illustrates an exemplary structure of a base station according to an embodiment of the disclosure.

FIG. 18 illustrates an exemplary structure of a UE according to an embodiment of the disclosure.

### MODE FOR THE INVENTION

In describing the disclosure below, a detailed description of known functions or configurations will be omitted when it is determined that the description may make the subject matter of the disclosure unnecessarily unclear. Hereinafter, embodiments of the disclosure will be described with reference to the accompanying drawings.

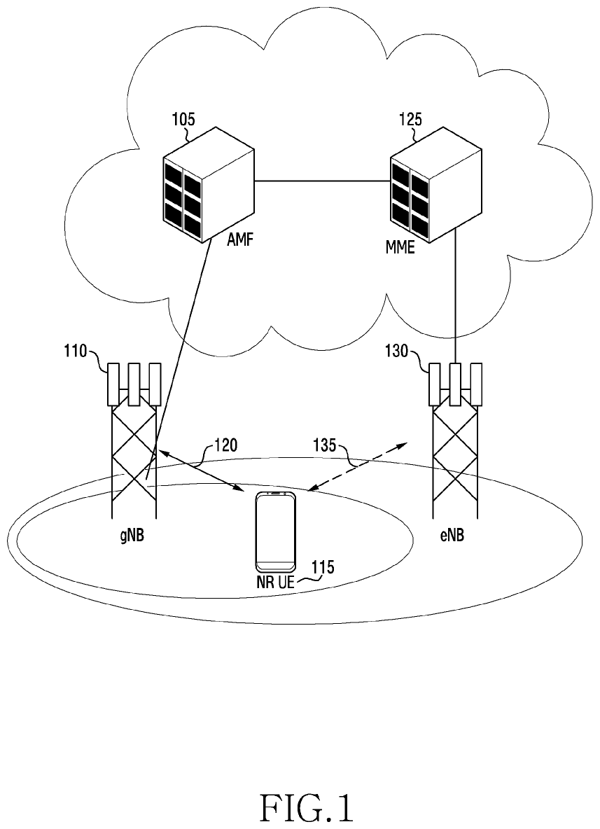

FIG. 1 illustrates a structure of a mobile communication system.

Referring to FIG. 1, a radio access network of a mobile communication system (e.g., new radio, NR) according to an embodiment may include a base station (e.g., new radio Node B, hereinafter gNB) 110 and/or an access and mobility management function (AMF) 105. For example, the AMF 105 may be included in a core network (e.g., new radio core network). A user equipment (e.g., new radio user equipment, hereinafter NR UE or terminal) 115 may access an external network via the gNB 110 and the AMF 105.

According to an embodiment, the gNB 110 may correspond to an evolved node B (eNB) 130 of an LTE system. That is, the gNB 110 may substantially function as an eNB 130.

According to an embodiment, the gNB 110 may be connected to the NR UE 115 via a wireless communication channel and provide relatively higher-efficiency services than a conventional Node B (e.g., eNB) (120).

According to an embodiment, in the mobile communication system (or next-generation mobile communication system), since all user traffic is serviced through a shared channel, a device that collects state information, such as buffer statuses, available transmit power states, and channel states of UEs, and performs scheduling accordingly may be required, and, for example, the device responsible for collecting and scheduling the state information may be the gNB 110.

According to an embodiment, in general, one gNB may control multiple cells. In order to implement ultrahigh-speed data transfer beyond LTE, the nase station (e.g., gNB) may use a wider bandwidth than the existing maximum bandwidth, may employ an orthogonal frequency division multiplexing (hereinafter referred to as OFDM) as a radio access technology, and may additionally integrate a beamforming technology therewith.

Furthermore, the base station (e.g., gNB) may employ an adaptive modulation & coding (hereinafter referred to as AMC) scheme for determining a modulation scheme and a channel coding rate according to a channel state of a UE.

According to an embodiment, the AMF 105 may perform functions such as mobility support, bearer configuration, and/or QoS configuration. The AMF 105 is a device responsible for various control functions as well as a mobility management function for a UE, and may be connected to multiple base stations. In addition, the mobile communication system may interwork with the conventional LTE system, and the AMF 105 may be connected to an MME 125 via a network interface. The MME 125 may be connected to the eNB 130 that is a conventional base station. A UE supporting LTE-NR dual connectivity may transmit and/or receive data while maintaining connections to both the gNB 110 and the eNB 130 (135).

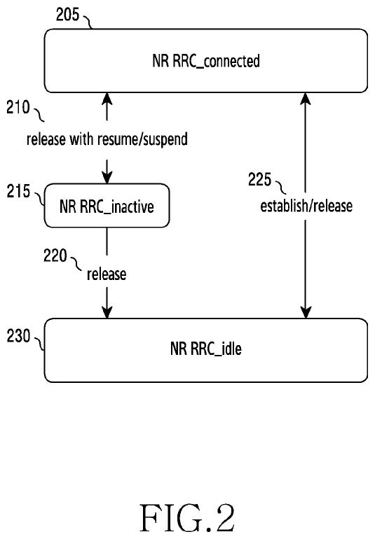

FIG. 2 is a diagram illustrating a radio access state transition in a mobile communication system.

Referring to FIG. 2, an apparatus (for example, a base station (BS) and/or a UE) may have three radio access states (radio resource control (RRC) states) in the mobile communication system according to an embodiment.

According to an embodiment, the apparatus (for example, the BS and/or the UE) of the mobile communication system may have a connected mode, an idle state, and/or an inactive mode. For example, a connected mode (RRC_CONNECTED) 205 may be a radio access state in which the UE can transmit and/or receive data. For example, an idle mode (RRC_IDLE) 230 may be a radio access state in which the UE monitors whether paging is transmitted to the UE itself. The connected mode and the idle mode are radio access states applied to the conventional LTE system, and detailed technique may be the same as that of the LTE system.

For example, an inactive (RRC_INACTIVE) radio access state 215 may be newly defined in the mobile communication system (or a next-generation mobile communication system). In the inactive radio access state, UE context is maintained in the BS and the UE and radio access network (RAN)-based paging may be supported. Characteristics of the inactive radio access state are described below.
Cell re-selection mobility;
Core network (CN)-NR RAN connection (both C/U-planes) has been established for UE;
The UE AS context is stored in at least one gNB and the UE;
Paging is initiated by NR RAN;
RAN-based notification area is managed by NR RAN;
NR RAN knows the RAN-based notification area which the UE belongs to;

According to an embodiment, the apparatus (for example, the BS or the UE) may transition from the new inactive radio access state to the connected mode or the idle state, based on a predetermined procedure. For example, the apparatus (for example, the BS or the UE) may switch from the inactive mode to the connected mode according to a resume process. For example, the apparatus (for example, the BS or the UE) may switch from the connected mode to the inactive mode by using a release procedure including suspend configuration information (210).

According to an embodiment, in the above-described procedures (for example, the resume process and the release procedure), one or more RRC messages may be transmitted and/or received between the UE and the BS, and the procedures may include one or more steps. As another example, the apparatus (for example, the BS or the UE) may switch from the inactive mode to the idle mode through the release procedure after resume (220). Switching between the connected mode and the idle mode may be based on the conventional LTE technology. That is, switching between the connected mode and the idle mode may be performed through an establishment or release procedure (225).

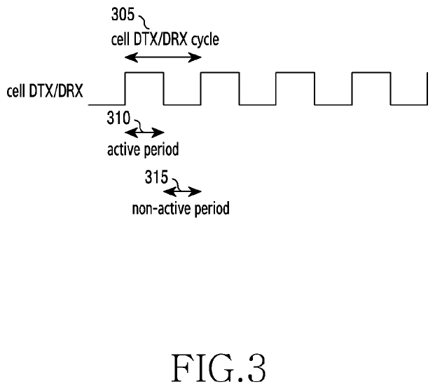

FIG. 3 is a diagram illustrating cell discontinuous transmission (DTX)/discontinuous reception (DRX) for reducing BS power consumption according to an embodiment.

Referring to FIG. 3, in the mobile communication system according to an embodiment, the BS should provide service to a plurality of UEs within a service area, thereby having much power consumption. Accordingly, various network energy saving (NES) technologies to reduce power consumption of the BS (for example, the gNB or eNB in FIG. 1) are being discussed. In the disclosure, a cell supporting at least one of the technologies for reducing power consumption may be referred to as a NES Cell, and a UE supporting at least one of the technologies for reducing power consumption may be referred o as a NES UE.

As examples of the technologies for reducing power consumption, the following candidate technologies are proposed in the NR standard.
Cell DTX/DRX
NES-aware conditional handover (CHO)
SSB-less/SIB-less cell
Cell (re)selection enhancement
UE wake-up signal (WUS)
UE assistance information for NES

According to an embodiment, cell DTX/DRX is technology of periodically transmitting and/or receiving data or turning on or off a device. As another example, cell DTX is technology in which the BS turns on/off data transmission in the downlink, and cell DRX is technology in which the BS turns on/off data reception in the uplink. Power consumption of the BS may be significantly reduced during a time period in which the BS turns off data transmission and reception.

According to an embodiment, when cell DTX or cell DRX is operated, the BS (for example, the gNB or the eNB in FIG. 1) may perform a predetermined operation corresponding to a period every predetermined cell DTX or cell DRX cycle 305 constituted by an active period 310 and a non-active period 315. For example, during the active period section, the BS may perform general operations for providing service to the existing UE. For example, in the non-active period, specifically, options of the BS operation below are considered to generally turn off data transmission and reception.
First option: corresponds to the case where the gNB turns off all transmission and reception for data traffic and reference signals during the cell DTX/DRX inactive period (gNB is expected to turn off all transmission and reception for data traffic and reference signal during Cell DTX/DRX non-active periods).
Second option: corresponds to the case where the gNB turns off transmission and reception only for data traffic during the cell DTX/DRX inactive period. That is, the gNB may still perform transmission and/or reception for reference signals (gNB is expected to turn off its transmission/reception only for data traffic during Cell DTX/DRX non-active periods (i.e., gNB will still transmit/receive reference signals)).
Third option: corresponds to the case where the gNB turns off dynamic transmission and/or reception during the cell DTX/DRX inactive period. That is, the gNB may still perform transmission and reception in periodic resources including semi-persistent scheduling (SPS), a CG-PUSCH, a scheduling request (SR), a random access channel (RACH), or a sound reference signal (SRS) (gNB is expected to turn off its dynamic data transmission/reception during Cell DTX/DRX non-active periods (i.e., gNB is expected to still perform transmission/reception in periodic resources, including SPS, CG-PUSCH, SR, RACH, and SRS)).
Fourth option: corresponds to the case where the gNB transmits only a channel state information-reference signal (CSI-RS) (gNB is expected to only transmit reference signals (e.g., CSI-RS for measurement)).

In the first option to the fourth option, the BS may not broadcast an SSB which is a common reference signal.

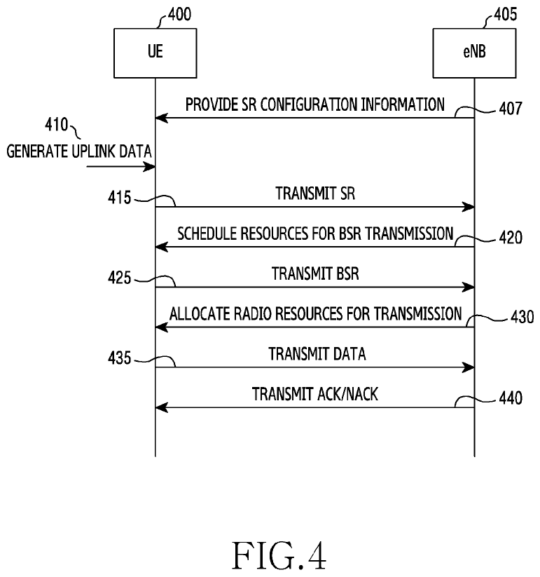

FIG. 4 is a diagram illustrating a process in which the UE transmits an SR and receives allocation of radio resources from the BS.

Referring to FIG. 4, in operation 407 according to an embodiment, a base station 405 may provide scheduling request (SR) configuration information to a UE 400. For example, the base station 405 may correspond to the BS (for example, the gNB or the eNB) in FIG. 1 (SR configuration provision).

For example, the SR configuration information may be referred to as SchedulingRequestConfigIE (information element) and/or SchedulingRequestResourceConfig IE. The SchedulingRequestConfig IE may include sr-ProhibitTimer and/or sr-TransMax parameter information.

According to an embodiment, the SchedulingRequestResourceConfig IE included in the SR configuration information may be used to indicate physical uplink control channel (PUCCH) physical layer used for transmitting the SR. That is, the SR configuration information may indicate resources for SR transmission. The base station may provide a plurality of pieces of SR configuration information to the UE, and each piece of the SR configuration information may be indicated as schedulingRequestId.

According to an embodiment, in operation 410, the UE may have uplink data to be transmitted. The UE may trigger a buffer status report (BSR), based on the following conditions (UL data arrives).
When uplink data corresponds to one logical channel (LCH) belonging to one logical channel group (LOG) and the LCH has a higher priority than any LCH belonging to the LCG.
When retxBSR-Timer expires and at least one LCH exists in the LCG or when periodicBSR-Timer expires

According to an embodiment, in operation 415, the UE may determine or identify whether radio resources to transmit a BSR making a request for data or a uplink (UL) grant exist (scheduling request (SR) (via PUCCH)).

According to an embodiment, when there is no resources to transmit the BSR (in case that), the UE may determine or identify whether a PUCCH which can be used for SR transmission is allocated.

According to an embodiment, when there is no PUCCH which can be used for SR transmission, the UE may perform random access.

According to an embodiment, when there is a PUCCH which can be used for SR transmission, the UE may transmit the SR to the base station by using the identified or determined PUCCH. In the case where the SR is transmitted to the base station or when the SR is transmitted to the base station, the timer of sr-ProhibitTimer may start.

According to an embodiment, in operation 420, the base station successfully receiving the SR may schedule radio resource through which the buffer status report (BSR) can be transmitted to the UE (UL grant for BSR). When the UE has not received scheduling of the radio resources through which the BSR can be transmitted and the timer of sr-ProhibitTimer expires, the UE may transmit the SR again. Further, the UE may increase a counter value of SR_COUNTER by one whenever SR transmission is attempted.

According to an embodiment, when the counter value becomes the same as dsr-TransMax corresponding to a configuration value, the UE may perform random access to the base station. For example, a value of dsr-TransMax may be configured in the UE by the base station. For example, the value of dsr-TransMax may have one value of {4, 8, 16, 32, 64}.

According to an embodiment, the BSR may be used to inform the base station or indicate how much transmission data the UE has.

According to an embodiment, in operation 425, the UE may transmit the BSR by using the allocated radio resources (BSR transmission). In operation 430, the base station may allocate radio resources through which packet data convergence protocol service data unit (PDCP SDU) can be transmitted (UL grant for data transmission). In operation 435, the UE may transmit data to the base station (data transmission). In operation 440, the base station may transmit ACK/NACK information on the data (acknowledge (ACK)/negative acknowledge (NACK) transmission).

According to an embodiment, the UE may transmit the SR to the base station by using periodically allocated SR radio resources. For example, the cycle of the SR radio resources may be configured in units of symbols or slots according to sub-carrier spacing (SCS).

For example, when the SR cycle is configured to be short, the UE may rapidly transmit its own SR to the base station. However, as the SR cycle is configured to be shorter, an occupancy rate of resources which should be allocated to the SR within PUCCH radio resources increases. When the SR cycle is higher than or equal to 10 ms, the occupancy rate of resources is low regardless of the number of UEs. However, when the SR cycle is configured to be short within 1 to 5 ms, the occupancy rate of radio resources significantly increases. This may be referred to from decrease in the number of radio resources which can be used for a hybrid automatic repeat request (HARQ), feedback information, or CSI information as well as the SR. Accordingly, for minimization of the delay time and decrease in the occupancy rate of radio resources, it is preferable to transmit the SR even in a PUCCH of a secondary cell (SCell). In a mobile communication system, the UE may transmit the scheduling request (SR) in a plurality of cells having the PUCCH.

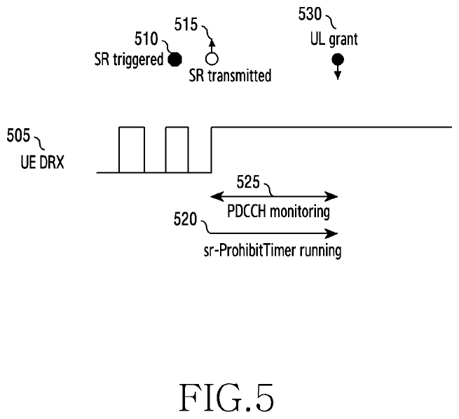

FIG. 5 is a diagram illustrating a DRX operation in an SR transmission process according to an embodiment.

Referring to FIG. 5, when a UE triggering the SR according to an embodiment (510) has valid PUCCH radio resources (or identifies radio resources), the UE may transmit the SR to the BS in operation 515.

According to an embodiment, even through DRX 505 for reducing power consumption is configured, the UE may ignore the DRX cycle from a time point at which the SR is transmitted and monitor a physical downlink control channel (PDCCH) (525). Further, when the SR is transmitted, the UE may run at least one timer (for example, sr-ProhibitTimer) (520). The UE may retransmit the SR which has been previously transmitted) while the timer is running.

According to an embodiment, after the SR is transmitted, the BS may provide or configure a UL grant (for example, uplink scheduling information) in the UE at a predetermined time point. The UE receiving the UL grant may consider or identify that there is no more pending SR and transmit predetermined data, for example, the BSR in uplink radio resources indicated by the UL grant. When the UE has not received the UL grant corresponding to the SR until sr-ProhibitTimer expires, the UE may retransmit the SR to the BS.

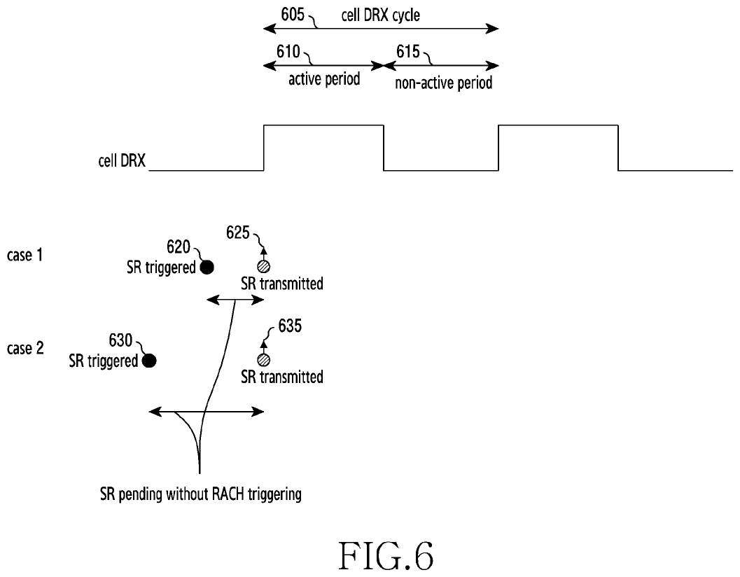

FIG. 6 is a diagram illustrating a transmission delay problem of the SR related to data transmission having a high priority according to an embodiment.

Referring to FIG. 6, in a NES cell to which cell DRX is applied according to an embodiment, an active period 610 in which uplink data can be received may arrive every cell DRX cycle 605. A section other than the active period may be a non-active period 615 in which uplink data reception is generally impossible. However, even though cell DRX is applied, the NES cell may support a random access process. For example, the NES cell may receive at least a preamble transmitted from the UE even in the non-active period. As another example, the NES cell may transmit a random access response (RSR) within an RAR window belonging to the active period of cell DTX and schedule msg3 transmitted from the UE to be transmitted in the active period of cell DRX.

According to an embodiment, when the time point at which the UE triggers the SR is within the non-active period section of cell DRX, the UE may not trigger the random access process and may delay transmission of the SR until the active period. When the active period arrives, the UE may transmit the pending SR to the NES cell. Accordingly, when the active period arrives soon at the time point 620 at which the UE triggers the SR, the delay time until the time point 625 at which the SR is transmitted after transmission of the SR is triggered is not long (case 1). However, when the active period does not arrive soon based on the time point 630 at which the UE triggers the SR, the delay time until the time point 635 at which the SR is transmitted after transmission of the SR is triggered is relatively long (case 2).

According to an embodiment, when traffic (for example, data) triggering the SR is traffic sensitive to the delay time (for example, extended reality (XR) or virtual reality (VR)/augmented reality (AR) traffic), the delay time generated in the NES cell is not preferable. That is, when traffic sensitive to the delay time is transmitted, the delay time to the time point at which the actual SR is transmitted after transmission of the SR is triggered cannot be tolerable. The type of traffic sensitive to the delay time may be considered or identified as high priority traffic.

According to an embodiment, when the time point at which the SR corresponding to traffic sensitive to the delay time is triggered is within the non-active period section of cell DRX, the UE may always make a request for scheduling through random access. However, the random access process needs several message exchanges in the uplink and/or downlink, thereby increasing signaling overhead and complexity between the BS and the UE. Accordingly, the disclosure discloses a method of triggering random access in order to make a request for uplink scheduling in the non-active period section according to an expected delay time. The proposed UE operation may be applied only to the SR corresponding to traffic sensitive to the delay time or traffic having a high priority.

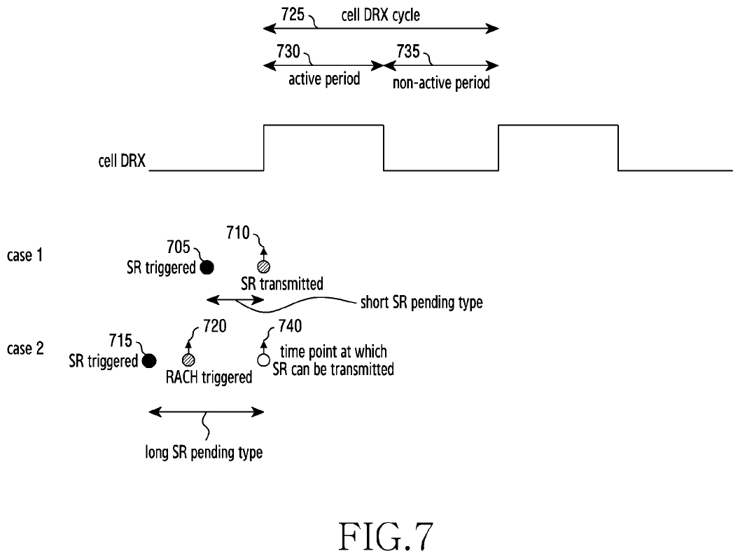

FIG. 7 is a diagram illustrating a method of reducing a delay time and power consumption according to an embodiment of the disclosure.

Referring to FIG. 7, during the non-active period section of cell DRX, when the time from a time point (for example, 705) at which the SR is triggered to a start time point (for example, 710) of an arriving active period (for example, 730) (or the first SR occasion in the arriving active period) is shorter than (or equal to or shorter than) a predetermined time (for example, short SR pending time) threshold value, the UE delays SR transmission until the active period and then transmits the SR. On the other hand, during the non-active period section of cell DRX, when the time from a time point (for example, 715) at which the SR is triggered to a start time point (for example, a time point 740 at which SR transmission is possible) of the arriving active period (or the first SR occasion in the arriving active period) is longer than or equal to (or longer than) a predetermined time (for example, long SR pending time) threshold value, the UE may perform the random access process to make a request for scheduling. For example, the UE may determine whether the delay time is longer than the threshold value and may transmit the SR or make a request for scheduling through the random access process (for example, 720) after the delay time arrives based on whether the delay time is longer than the threshold value.

According to an embodiment, the time threshold value (or period threshold value) may be configured or predefined by the BS. For example, the time threshold value may be configured in the UE by means of RRC signaling. For example, the time threshold value may be provided to or configured in the UE for each logical channel (LCH), for each logical channel group (LCG), or for each piece of SR configuration information (for example, SchedulingRequestId).

For example, when the time threshold value is provided for each LCH and all or a plurality of LCHs corresponds to one SR, one time threshold value may be applied to or configured in the UE. For example, a time threshold value corresponding to an LCH having the highest priority or an LCH having the lowest priority among the plurality of LCHs may be applied to be configured in the UE. When the time threshold value is provided for each LCG and all or a plurality of LCGs correspond to one SR, one time threshold value may be applied and, for example, a time threshold value corresponding to an LCG having the highest priority or an LCG having the lowest priority among the plurality of LCGs may be applied to or configured in the UE.

According to an embodiment, in addition to the time condition, the type of traffic may be considered as an additional condition. For example, the above-described time condition may be applied to the SR corresponding to traffic sensitive to the delay time or traffic having a higher priority. That is, a time threshold value corresponding to traffic having the highest priority may be applied to or configured in the UE.

According to an embodiment, traffic sensitive to the delay time or traffic having the high priority may be configured or predefined by the BS. For example, when traffic having the high priority is configured by the BS, the BS may provide or configure logical channel priority information or LCG information to which the time condition should be applied to or in the UE. Alternatively, the SR related to XR traffic may apply the above-described time condition.

According to an embodiment, the NES cell may configure predetermined SR radio resources to the non-active period of cell DRX as well. The SR radio resources may be used only for a predetermined LCH or LCG configured or predefined by the NES cell or SR transmission for predetermined special traffic (for example, XR).

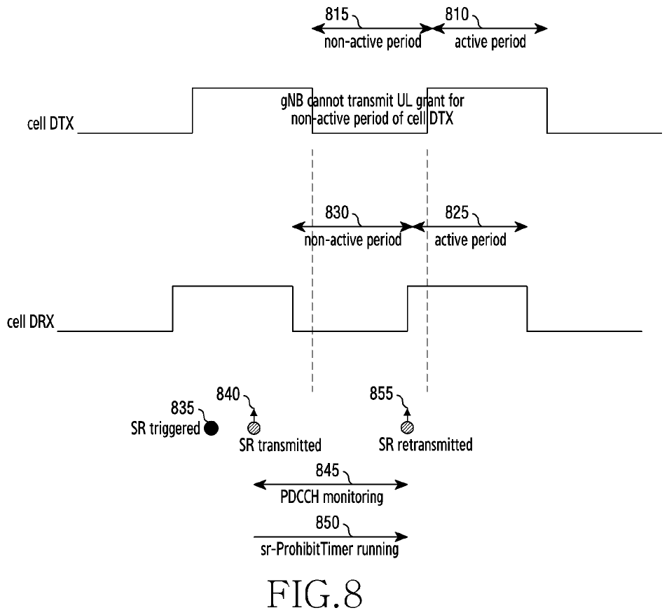

FIG. 8 is a diagram illustrating an SR retransmission problem due to the non-active period of cell DTX according to an embodiment.

Referring to FIG. 8, when a time point at which the UE according to an embodiment should receive a UL grant in response to the SR after the UE transmits the SR is the non-active period of cell DTX, a time point at which the NES cell provides the UL grant to the UE may be delayed.

When sr-ProhibitTimer which starts running along with SR transmission expires, the UE may retransmit the SR. That is, due to the non-active period of cell DTX, unnecessary SR retransmission may be generated. For example, the UE may trigger the SR (835) and transmit the SR to the NES cell in the active period of cell DRX (840). After transmitting the SR, the UE may run sr-ProhibitTimer (850) and monitor a PDCCH (845).

According to an embodiment, due to the non-active period 815 of cell DTX, the NES cell receiving the SR cannot provide the UL grant (uplink scheduling information) to the UE through the PDCCH. When sr-ProhibitTimer which starts running along with SR transmission expires, the UE may retransmit the SR in the active period 825 of cell DRX (855). When the active period 810 of cell DTX arrives, the NES cell will provide the UL grant, and thus SR retransmission may be unnecessary. Further, in terms of UE power consumption, the NES cell cannot provide the UL grant in the non-active period of cell DTX, so that monitoring the PDCCH during the period may be an unnecessary operation causing the power consumption.

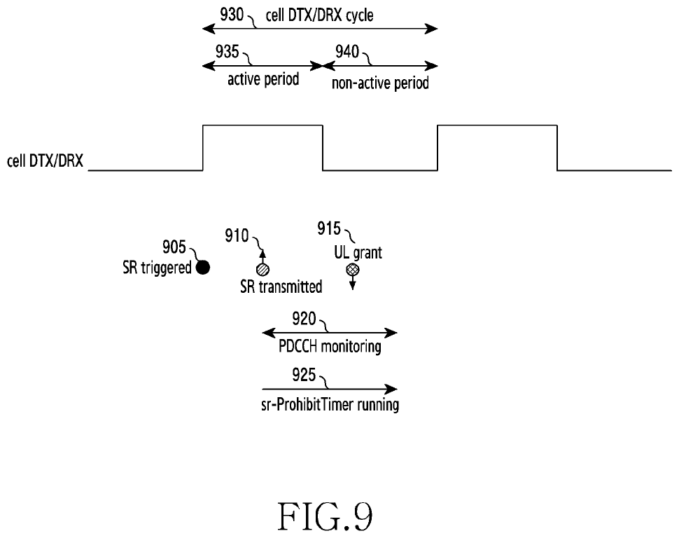

FIG. 9 is a diagram illustrating a method of reducing power consumption according to an embodiment of the disclosure.

Referring to FIG. 9, when the NES cell according to an embodiment receives the SR from the UE (910), the NES cell may schedule a UL grant 915 regardless of a non-active period 940 of cell DTX.

According to an embodiment, for all SRs, the NES cell may provide the UL grant regardless of the non-active period of cell DTX or separately configure a predetermined SR for providing the UL grant regardless of the non-active period of cell DTX. For example, SR configuration information may include an indicator indicating an SR (for example, urgent SR) having a characteristic of providing the UL grant regardless of the non-active period. When the UE transmits the SR in an SR occasion (for example, radio resources through which the SR can be transmitted) indicated by the SR configuration information, the NES cell may provide the UL grant to the UE regardless of the non-active period of cell DTX. After transmitting the SR, the UE may consider or identify that cell DTX corresponds to the active period during the running sr-ProhibitTimer (925) and monitor the PDCCH (920).

According to an embodiment, after receiving the SR, the NES cell may indicate that cell DTX or the non-active period of cell DTX is not applied during a predetermined time section through downlink control information (DCI). The UE receiving the DCI may determine whether to monitor the PDCCH during the non-active period of DTX after SR transmission. UEs irrelevant to the SR may also recognize or identify that the non-active period of cell DTX is not applied during a predetermined time section and perform an operation which could not be performed during the non-active period of cell DTX for another purpose.

FIG. 9 illustrates the case where patterns of cell DTX and cell DRX are the same for convenience of description, but the content described in FIG. 9 of the disclosure can be applied to the case where the patterns are different.

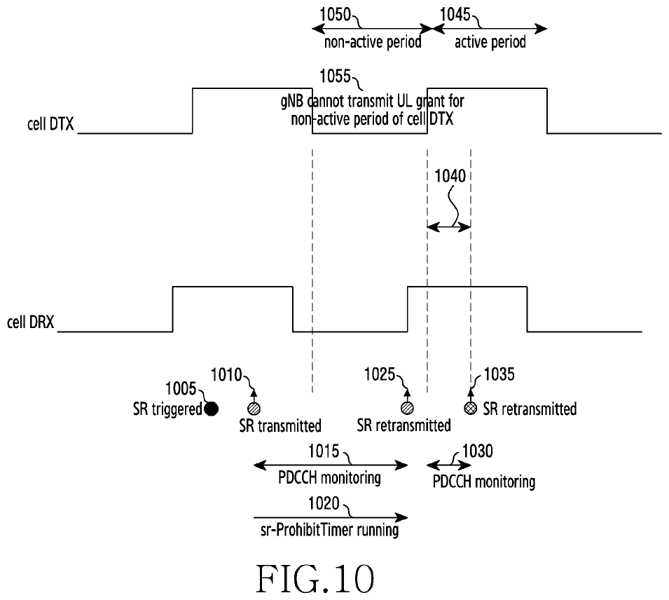

FIG. 10 is a diagram illustrating a method of reducing power consumption according to an embodiment of the disclosure.

Referring to FIG. 10, in case that the non-active period of cell DTX has arrived when sr-ProhibitTimer according to an embodiment expires, the UE may defer SR retransmission until a predetermined time passes after the active period of cell DTX arrives.

According to an embodiment, the predetermined time is 0 ms or longer and may be configured or predefined by the NES cell. For example, the NES cell may provide predetermined time information to the UE in units of absolute time, symbols, or slots.

According to an embodiment, in case that the non-active period of cell DTX has arrives when sr-ProhibitTimer 1020 expires, the UE triggering the SR (1005) may not perform SR retransmission (1025). Instead, when an active period 1045 of cell DTX arrives, the UE may additionally check or identify whether the UL grant is provided from the NES cell through PDCCH monitoring 1030 for a configured predetermined time 1040. When the UL grant has not been provided from the NES cell until the configured predetermined time passes, the UE may retransmit the SR in the (arriving) active period of cell DRX (1035). Alternatively, after the predetermined time, when the non-active period has arrived, the UE may perform PDCCH monitoring whether the UL grant is provided from the NES cell until the active period of cell DRX arrives.

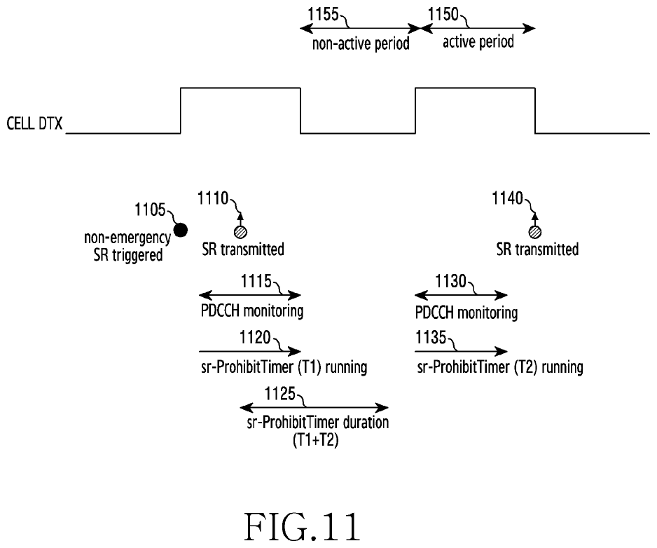

FIG. 11 is a diagram illustrating a method of reducing power consumption according to an embodiment of the disclosure.

Referring to FIG. 11, based on a configuration of the NES cell or a predetermined condition according to an embodiment, the UE may monitor the PDCCH to receive a UL grant corresponding to the SR transmitted only in an active period of cell DTX and run sr-ProhibitTimer.

According to an embodiment, in case that a non-active period 1155 of cell DTX arrives while sr-ProhibitTimer is running, the UE may suspend the timer (for example, sr-ProhibitTimer) (1120) and also stop PDCCH monitoring (1115).

According to an embodiment, when an active period 1150 of cell DTX arrives again, the UE may resume the suspended timer (1135). As described above, expansion of sr-ProhibitTimer (for example, resumption of the timer) may not be preferable to traffic sensitive to the delay time.

Accordingly, the operation of suspending and resuming the timer in the disclosure may be performed according to the configuration of the NES cell or only when a predetermined condition is satisfied. For example, the predetermined condition may include a condition in which traffic corresponding to the transmitted SR in not sensitive to the delay time in which case the UE may perform the operation. The proposed methods may be simultaneously configured and applied, or at least one of the methods of reducing power consumption according to the predetermined configuration or condition by the BS may be applied. That is, the methods of decreasing the delay time and reducing power the power consumption may be combined unless they are contradictory to each other. For example, the method described in FIG. 9 may be applied to the UE when uplink traffic corresponding to the transmitted SR is sensitive to the delay time, and the method described in FIG. 11 may be applied to the UE when uplink traffic corresponding to the transmitted SR is not sensitive to the delay time.

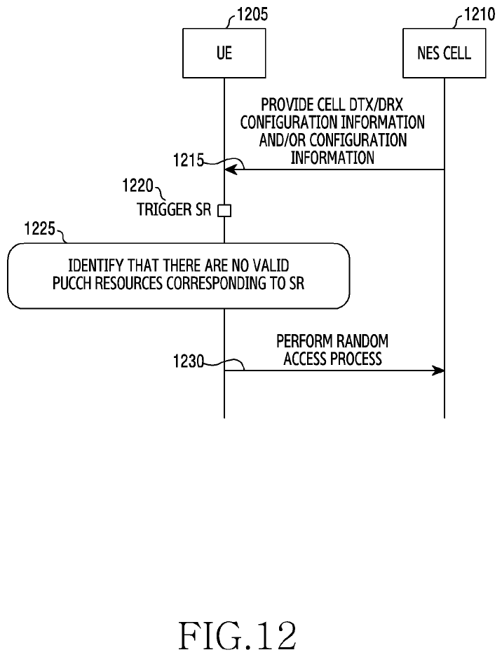

FIG. 12 is a diagram illustrating a method of reducing power consumption according to an embodiment of the disclosure.

Referring to FIG. 12, when the UE triggering the SR during a non-active period of cell DRX according to an embodiment recognizes that there are no valid PUCCH radio resources corresponding to the pending SR in an arriving active period of cell DRX or a value of SR_COUNTER reaches sr-TransMax, the UE may perform a random access process even during the non-active period of cell DRX to make a request for uplink scheduling.

According to an embodiment, a NES cell 1210 may provide or configure cell DTX/DRX configuration information and/or SR configuration information to or in a UE 1205 (1215) (Cell DTX/DRX configuration and/or SR configuration provision). Accordingly, the UE 1205 may recognize or identify cell DTX/DRX patterns and determine or identify whether there are PUCCH radio resources through which the SR can be transmitted every active period of cell DRX. For example, when the UE triggering the SR (SR triggered) (1220) recognizes there are no valid PUCCH radio resources corresponding to the pending SR (1225) (during non-active period of Cell DRX, identify if the MAC entity has no valid PUCCH resource configured for the pending SR (in coming active period of Cell DRX) or if SR_COUNTER reaches to sr-TransMax), the UE may immediately perform a random access process to the NES cell and make a request for uplink scheduling (1230) (perform random access).

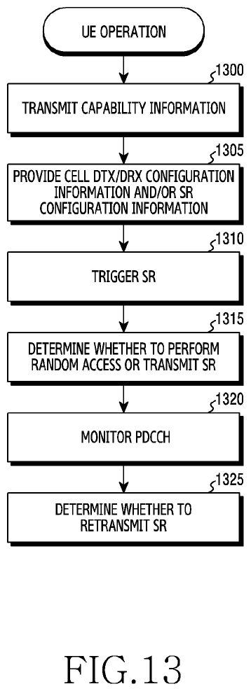

FIG. 13 is a flowchart illustrating a UE operation according to an embodiment of the disclosure.

Referring to FIG. 13, in operation 1305 according to an embodiment, the UE reports its own capability information. For example, the UE may transmit UE capability information (transmit UE capabilities) in operation 1300.

For example, the capability information may include indicators indicating whether cell DTX and cell DRX are supported. For example, the capability information may include indicators indicating whether the methods of reducing power consumption of the disclosure are supported. That is, information on the capability information may include a field indicating whether the methods of reducing power consumption are supported.

According to an embodiment, in operation 1305, the UE may receive provision or configuration of cell DTX/DRX configuration information from the NES cell (receive cell DTX/DRX configuration and SR configuration). For example, each of the cell DTX and/or cell DRX configuration information may be provided through a predetermined RRC message, and the cell DTX and cell DRX patterns may be constituted by a cycle, offset information, and/or duration information of an active period (or non-active period). Further, the UE may receive provision of SR configuration information from the NES cell.

According to an embodiment, in operation 1310, the UE may trigger the SR in order to make a request for uplink radio resources for transmitting a BSR (trigger SR).

According to an embodiment, in operation 1315, the UE may recognize or identify that the SR cannot be immediately transmitted due to the non-active period and determine whether to perform a random access process or transmit the SR in the arriving active period (decided whether to transmit SR or initiate Random access). For example, the UE may determine whether to perform the random access process or transmit the SR in the arriving active period, based on the type of transmitted traffic or a delay time.

According to an embodiment, in operation 1320, the UE may monitor a PDCCH according to an embodiment after the SR transmission (monitor PDCCH).

According to an embodiment, in operation 1325, the UE may retransmit the SR when the UE does not receive a UL grant corresponding to the transmitted SR for a predetermined time (decide whether to retransmit SR).

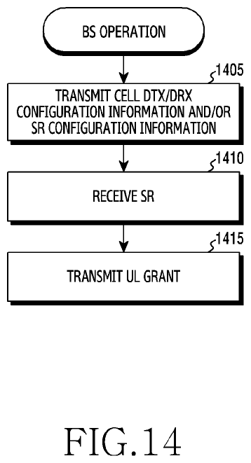

FIG. 14 is a flowchart of a BS operation according to an embodiment.

Referring to FIG. 14, in operation 1405 according to an embodiment, the BS may provide or transmit cell DTX/DRX configuration information and SR configuration information to the NES UE (transmit cell DTX/DRX configuration and SR configuration).

According to an embodiment, in operation 1410, the BS may receive the SR from the UE in an active period of cell DRX (receive SR from the UE).

According to an embodiment, in operation 1415, the BS transmits a UL grant to the UE according to the embodiment (provide UL grant).

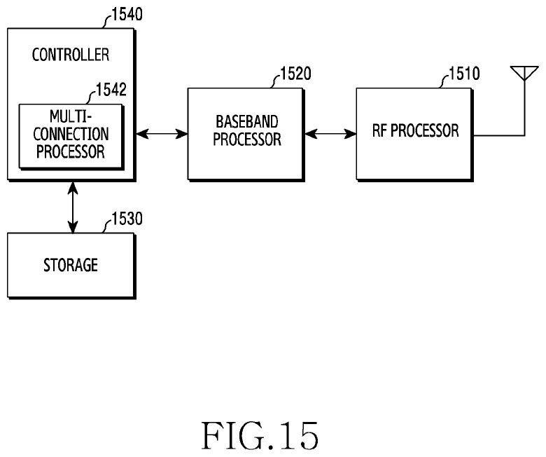

FIG. 15 is a block diagram illustrating an internal structure of a UE according to an embodiment.

Referring to FIG. 15, the UE may include a radio frequency (RF) processor 1510, a baseband processor 1520, a storage 1530, and a controller 1540.

According to an embodiment, the RF processor 1510 may perform a function, such as signal band conversion, amplification, etc., for transmitting or receiving a signal through a wireless channel. That is, the RF processing unit 1510 up-converts a baseband signal provided from the baseband processing unit 1520 to an RF band signal, transmits the same through an antenna, and down-converts an RF band signal received through the antenna to a baseband signal. For example, the RF processor 1510 may include a transmission filter, a reception filter, an amplifier, a mixer, an oscillator, a digital-to-analog converter (DAC), and/or an analog-to-digital converter (ADC). Although only one antenna is illustrated in the drawing, the UE may include multiple antennas.

In addition, the RF processor 1510 may include multiple RF chains. Furthermore, the RF processor 1510 may perform beamforming. For the beamforming, the RF processor 1510 may adjust the phase and magnitude of signals transmitted/received through multiple antennas or antenna elements, respectively. In addition, the RF processor may perform MIMO, and may receive multiple layers when performing a MIMO operation.

According to an embodiment, the baseband processor 1520 may perform a function of conversion between a baseband signal and a bitstream according to a physical layer specification of a system. For example, during data transmission, the baseband processor 1520 may encode and modulate a transmitted bitstring to generate complex symbols. In addition, during data reception, the baseband processor 1520 may demodulate and decode a baseband signal provided from the RF processor 1510 to restore a received bitstring. For example, when following the orthogonal frequency division multiplexing (OFDM) scheme, during data transmission, the baseband processor 1520 may encode and modulate a transmitted bitstring to generate complex symbols, may map the complex symbols to subcarriers, and may configure OFDM symbols through inverse fast Fourier transform (IFFT) operation and cyclic prefix (CP) insertion. In addition, in case of data reception, the baseband processor 1520 may split a baseband signal provided from the RF processor 1510 at the OFDM symbol level, may restore signals mapped to subcarriers through a fast Fourier transform (FFT) operation, and may restore a received bitstring through demodulation and decoding.

According to an embodiment, the baseband processor 1520 and the RF processor 1510 may transmit and/or receive a signal as described above. Therefore, the baseband processor 1520 and the RF processor 1510 may be referred to as a transmitter, a receiver, a transceiver, or a communication unit. Furthermore, at least one of the baseband processor 1520 and the RF processor 1510 may include multiple communication modules to support multiple different radio access technologies. In addition, at least one of the baseband processor 1520 and the RF processor 1510 may include different communication modules to process signals in different frequency bands. For example, the different radio access technologies may include wireless LANs (for example, IEEE 802.11), cellular networks (for example, LTE), and the like. In addition, the different frequency bands may include super high frequency (SHF) (e.g., 2 NRHz) bands and millimeter wave (mmWave) (e.g., 60 GHz) bands.

According to an embodiment, the storage 1530 may store data such as a basic program, an application program, and configuration information for an operation of the UE. Particularly, the storage 1530 may store information on a second access node configured to perform wireless communication by using a second radio access technology. In addition, the storage 1530 may provide the stored data at the request of the controller 1540.

The controller 1540 may control the overall operation of the UE. For example, the controller 1540 may transmit and/or receive a signal via the baseband processor 1520 and the RF processor 1510. In addition, the controller 1540 records data in the storage 1530 and reads the data from the storage 1530. To this end, the controller 1540 may include at least one processor. For example, the controller 1540 may include a communication processor (CP) configured to perform control for communication, and an application processor (AP) configured to control upper layers such as application programs.

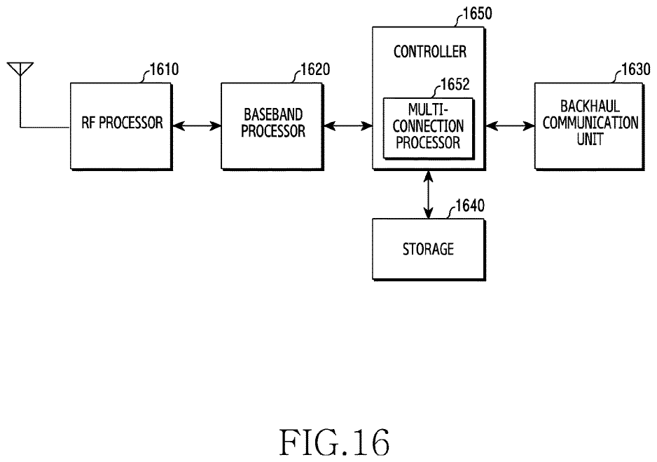

FIG. 16 is a block diagram illustrating a structure of a base station according to an embodiment.

Referring to FIG. 16, the base station may include an RF processor 1610, a baseband processor 1620, a backhaul communicator 1630, a storage 1640, and a controller 1650.

According to an embodiment, the RF processor 1610 may perform functions for transmitting/receiving signals through a radio channel, such as signal band conversion and amplification. That is, the RF processor 1610 may up-convert a baseband signal provided from the baseband processor 1620 to an RF band signal, may transmit the same through an antenna, and may down-convert an RF band signal received through the antenna to a baseband signal. For example, the RF processor 1610 may include a transmission filter, a reception filter, an amplifier, a mixer, an oscillator, a DAC, and an ADC. Although only one antenna is illustrated in the drawing, the first access node may include multiple antennas. In addition, the RF processor 1610 may include multiple RF chains.

Furthermore, the RF processor 1610 may perform beamforming. For the beamforming, the RF processor 1610 may adjust the phase and magnitude of signals transmitted/received through multiple antennas or antenna elements, respectively. The RF processor may transmit one or more layers to perform a downward MIMO operation.

According to an embodiment, the baseband processor 1620 may perform a function of conversion between a baseband signal and a bitstream according to a physical layer specification of a first wireless access technology. For example, during data transmission, the baseband processor 1620 may encode and modulate a transmitted bitstring to generate complex symbols. In addition, during data reception, the baseband processor 1620 may restore the received bit stream through demodulation and decoding of the baseband signal provided from the RF processor 1610. For example, when following the OFDM scheme, during data transmission, the baseband processor 1620 may encode and modulate a transmitted bitstring to generate complex symbols, may map the complex symbols to subcarriers, and may configure OFDM symbols through IFFT operation and CP insertion. In addition, during data reception, the baseband processor 1620 may split a baseband signal provided from the RF processor 1610 at the OFDM symbol level, may restore signals mapped to subcarriers through FFT operation, and may restore a received bitstring through demodulation and decoding. The baseband processor 1620 and the RF processor 1610 transmit and receive signals as described above. Therefore, the baseband processor 1620 and the RF processor 1610 may be referred to as a transmitter, a receiver, a transceiver, or a communication unit.

According to an embodiment, the backhaul communication unit 1630 may provide an interface for performing communication with other nodes within a network. That is, the backhaul communication unit 1630 converts bitstrings transmitted from the main base station to other nodes, for example, an auxiliary base station, a core network, etc., into physical signals, and converts physical signals received from the other nodes into bitstrings.

The storage 1640 may store basic programs, application programs, and data, such as configuration information, for operation of the main base station. Particularly, the storage 1640 may store information on a bearer allocated to a connected UE, a measurement result reported from the connected UE, and the like. In addition, the storage 1640 may store information serving as criteria for determining whether to provide or stop multiple connections to UEs. In addition, the storage 1640 may provide the stored data at the request of the controller 1650.

According to an embodiment, the controller 1650 may control the overall operation of the main base station. For example, the controller 1650 transmits/receives signals through the baseband processor 1620 and the RF processor 1610 or through the backhaul communication unit 1630. In addition, the controller1650 records data in the storage 1640 and reads the data from the storage 1640. To this end, the controller 1650 may include at least one processor.

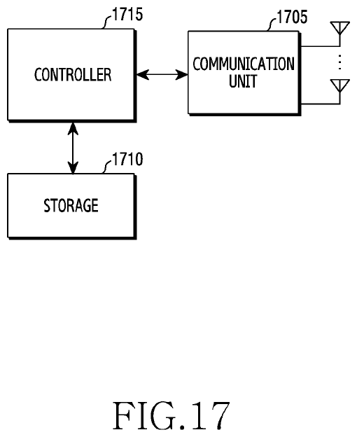

FIG. 17 illustrates an exemplary structure of a base station according to an embodiment of the disclosure.

Referring to FIG. 17, the structure according to an embodiment illustrated in FIG. 17 may be understood as a structure of the gNB and/or eNB in FIG. 1. As used herein, such terms as “. . . unit” and “. . . er” refer to a unit configured to process at least one function or operation, and may be implemented as hardware, software, or a combination of hardware and software.

According to an embodiment, the base station may include a communication unit 1705, a storage 1710, and/or a controller 1715.

The communication unit 1705 performs functions for transmitting/receiving signals through a radio channel. For example, the communication unit 1705 performs functions of conversion between baseband signals and bitstrings according to the physical layer specifications of the system. For example, during data transmission, the communication unit 1705 generates complex symbols by encoding and modulating a transmission bitstream. In addition, during data reception, the communication unit 1705 demodulates and decodes a baseband signal to restore a received bitstring. In addition, the communication unit 1705 up-converts a baseband signal to an RF band signal, transmits the same through an antenna, and down-converts an RF band signal received through the antenna to a baseband signal. For example, the communication unit 1705 may include a transmission filter, a reception filter, an amplifier, a mixer, an oscillator, a DAC, and an ADC.

In addition, the communication unit 1705 may include multiple transmission/reception paths. Moreover, the communication unit 1705 may include at least one antenna array including multiple antenna elements. In terms of hardware, the communication unit 1705 may include a digital circuit and an analog circuit (e.g., a radio frequency integrated circuit (RFIC)). The digital circuit and the analog circuit may be implemented as a single package. In addition, the communication unit 1705 may include multiple RF chains. Furthermore, the communication unit 1705 may perform beamforming.

The communication unit 1705 transmits and receives signals as described above. Accordingly, all or part of the communication unit 1705 may be referred to as a “transmitter”, a “receiver”, or a “transceiver”. In addition, as used in the following description, the meaning of “transmission and reception performed through a radio channel” includes the meaning that the above-described processing is performed by the communication unit 1705.

The storage 1710 may store basic programs, application programs, and data, such as configuration information, for operation of the main base station. The storage 1710 may include a volatile memory, a nonvolatile memory, or a combination of a volatile memory and a nonvolatile memory. In addition, the storage 1710 provides the stored data at the request of the controller 1715.

The controller 1715 controls the overall operation of the base station. For example, the controller 1715 transmits/receives signals through the communication unit 1705. In addition, the controller 1715 records data in the storage 1710 and reads the data from the storage 1710. In addition, the controller 1715 may perform functions of protocol stacks required by communication specifications. To this end, the controller 1715 may include at least one processor or microprocessor, or may be a part of a processor. In addition, a part of the communication unit 1705 and the controller 1715 may be referred to as a communication processor (CP). According to various embodiments, the controller 1715 may control to perform synchronization by using a wireless communication network. For example, the controller 1715 may control the base station to perform operations according to various embodiments described above.

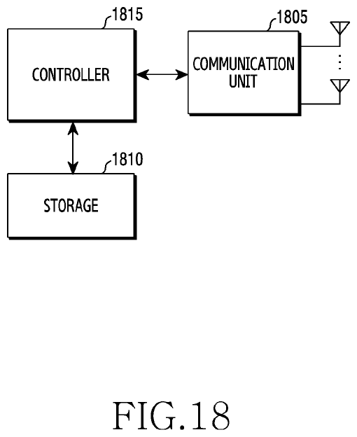

FIG. 18 illustrates an exemplary structure of a UE according to an embodiment of the disclosure. The structure illustrated in FIG. 18 may be understood as a structure of the UE (or NR UE) in FIG. 1. As used herein, such terms as “. . . unit” and “. . . er” refer to a unit configured to process at least one function or operation, and may be implemented as hardware, software, or a combination of hardware and software.

Referring to FIG. 18, the UE includes a communication unit 1805, a storage 1810, and a controller 1815.

The communication unit 1805 performs functions for transmitting/receiving signals through a radio channel. For example, the communication unit 1805 performs functions of conversion between baseband signals and bitstrings according to the physical layer specifications of the system. For example, during data transmission, the communication unit 1805 generates complex symbols by encoding and modulating a transmission bitstream. In addition, during data reception, the communication unit 1805 demodulates and decodes a baseband signal to restore a received bitstring. In addition, the communication unit 1805 up-converts a baseband signal to an RF band signal, transmits the same through an antenna, and down-converts an RF band signal received through the antenna to a baseband signal. For example, the communication unit 1805 may include a transmission filter, a reception filter, an amplifier, a mixer, an oscillator, a DAC, and an ADC.

In addition, the communication unit 1805 may include multiple transmission/reception paths. Moreover, the communication unit 1805 may include at least one antenna array including multiple antenna elements. In terms of hardware, the communication unit 1805 may include a digital circuit and an analog circuit (e.g., a radio frequency integrated circuit (RFIC)). The digital circuit and the analog circuit may be implemented as a single package. In addition, the communication unit 1805 may include multiple RF chains. Furthermore, the communication unit 1805 may perform beamforming.

The communication unit 1805 transmits and receives signals as described above. Accordingly, all or part of the communication unit 1805 may be referred to as a “transmitter”, a “receiver”, or a “transceiver”. In addition, as used in the following description, the meaning of “transmission and reception performed through a radio channel” includes the meaning that the above-described processing is performed by the communication unit 1805.

The storage 1810 stores basic programs, application programs, and data, such as configuration information, for operation of the main base station. The storage 1810 may include a volatile memory, a nonvolatile memory, or a combination of a volatile memory and a nonvolatile memory. In addition, the storage 1810 provides the stored data at the request of the controller 1815.

The controller 1815 controls the overall operation of the UE. For example, the controller 1815 transmits/receives signals through the communication unit 1805. In addition, the controller 1815 records data in the storage 1810 and reads the data from the storage 1810. In addition, the controller 1815 may perform functions of protocol stacks required by communication specifications. To this end, the controller 1815 may include at least one processor or microprocessor, or may be a part of a processor. In addition, a part of the communication unit 1805 and the controller 1815 may be referred to as a communication processor (CP). According to various embodiments, the controller 1815 may control to perform synchronization by using a wireless communication network. For example, the controller 1815 may control the UE to perform operations according to various embodiments described below.

1. A method performed by a user equipment (UE) in a wireless communication system, the method comprising:
receiving, from a base station, configuration information on cell discontinuous reception (DRX) configured for a cell of the base station;
identifying that the cell is in a non-active period of the cell DRX based on the configuration information; and
in case that an emergency service is to be initiated while the cell is in the non-active period, performing a random access procedure.

2. The method of claim 1, wherein a scheduling request (SR) is not transmitted while the cell is in the non-active period,
wherein a timer associated with the SR is not started while the cell is in the non-active period, and
wherein the configuration information comprises at least one of information on a cycle and an offset of the cell DRX or information on a duration associated with an active period of the cell DRX.

3. The method of claim 1, comprising:
identifying data to be transmitted;
identifying whether a physical uplink control channel (PUCCH) resource corresponding to an active period subsequent to the non-active period exists, wherein the PUCCH resource is associated with an SR for transmission of the data; and
in case that the PUCCH resource corresponding to the active period does not exist, performing the random access procedure.

4. The method of claim 1, comprising:
transmitting, the base station, an SR to while the cell is in an active period of the cell DRX;
receiving, from the base station, downlink control information (DCI) indicating that the cell DRX is deactivated for a predetermined period while the cell is in the non-active period of the cell DRX; and
monitoring a physical downlink control channel (PDCCH) for the predetermined period.

5. A user equipment (UE) in a wireless communication system, the UE comprising:
a transceiver; and
a controller coupled to the transceiver,
wherein the controller is configured to:
receive, from a base station, configuration information on cell discontinuous reception (DRX) configured for a cell of the base station;
identify that the cell is in a non-active period of the cell DRX based on the configuration information; and
in case that an emergency service is to be initiated while the cell is in the non-active period, perform a random access procedure.

6. The UE of claim 5, wherein a scheduling request (SR) is not transmitted while the cell is in the non-active period,
wherein a timer associated with the SR is not started while the cell is in the non-active period, and
wherein the configuration information comprises at least one of information on a cycle and an offset of the cell DRX or information on a duration associated with an active period of the cell DRX.

7. The UE of claim 5, wherein the controller is configured to:
identify data to be transmitted;
identify whether a physical uplink control channel (PUCCH) resource corresponding to an active period subsequent to the non-active period exists; and
in case that the PUCCH resource corresponding to the active period does not exist, perform the random access procedure, and
wherein the PUCCH resource is associated with an SR for transmission of the data.

8. The UE of claim 5, wherein the controller is configured to:
transmit, to the base station, an SR while the cell is in an active period of the cell DRX;
receive, from the base station, downlink control information (DCI) indicating that the cell DRX is deactivated for a predetermined period while the cell is in the non-active period of the cell DRX; and
monitor a physical downlink control channel (PDCCH) for the predetermined period.

9. A method performed by a base station in a wireless communication system, the method comprising:
transmitting, to a user equipment (UE), configuration information on cell discontinuous reception (DRX) configured for a cell of the base station; and
in case that an emergency service is to be initiated while the cell is in a non-active period of the cell DRX, performing a random access procedure,
wherein the non-active period is based on the configuration information.

10. The method of claim 9, wherein a scheduling request (SR) is not received while the cell is in the non-active period,
wherein a timer associated with the SR is not started while the cell is in the non-active period, and
wherein the configuration information comprises at least one of information on a cycle and an offset of the cell DRX or information on a duration associated with an active period of the cell DRX.

11. The method of claim 9, wherein, in case that a physical uplink control channel (PUCCH) resource corresponding to an active period subsequent to the non-active period does not exist, the random access procedure is performed, and
wherein the PUCCH resource is associated with an SR for reception of data.

12. The method of claim 9, comprising:
receiving, from the UE, an SR while the cell is in an active period of the cell DRX; and
transmitting, to the UE, downlink control information (DCI) indicating that the cell DRX is deactivated for a predetermined period while the cell is in the non-active period of the cell DRX.

13. A base station in a wireless communication system, the base station comprising:
a transceiver; and
a controller coupled to the transceiver,
wherein the controller is configured to:
transmit, to a user equipment (UE), configuration information on cell discontinuous reception (DRX) configured for a cell of the BS; and
in case that an emergency service is to be initiated while the cell is in a non-active period of the cell DRX, perform a random access procedure, and
wherein the non-active period is based on the configuration information.

14. The base station of claim 13, wherein a scheduling request (SR) is not received while the cell is in the non-active period,
wherein a timer associated with the SR is not started while the cell is in the non-active period, and
wherein the configuration information comprises at least one of information on a cycle and an offset of the cell DRX or information on a duration associated with an active period of the cell DRX.

15. The base station of claim 13, wherein, in case that a physical uplink control channel (PUCCH) resource corresponding to an active period subsequent to the non-active period does not exist, the random access procedure is performed, and
wherein the PUCCH resource is associated with an SR for reception of data.
